(19) United States
(12) Patent Application Publication
(10) Pub. No.: US 2008/0250854 A1
(43) Pub. Date: Oct. 16, 2008

(54) Mass flow device using a flow equalizer for improving the output response

(76) Inventors: Junhua Ding, Tewksbury, MA (US); Jeffrey Anastas, Kennebunk, ME (US)

Correspondence Address: MCDERMOTT WILL & EMERY LLP, 28 STATE STREET, BOSTON, MA, 02109-1775, US

(21) Appl. No.: 11/786,668

(22) Filed: Apr. 12, 2007

(51) Int. Cl. G01F 15/00

(52) U.S. Cl. 73/198

(57) ABSTRACT

A mass flow device comprises an inlet and an outlet; a bypass and a laminar flow element disposed within the bypass. The device also includes a sensor constructed so as to provide an output signal representative of the flow rate through the mass flow device, the sensor including a tube in fluid communication with the inlet and the laminar flow element at an upstream connection location, and the outlet and the laminar flow element at a downstream connection location. A flow equalizer is disposed between the inlet and the upstream connection location, wherein the flow equalizer includes a porous medium constructed with an interconnected porosity so as to greatly reduce the flow disturbance to the sensor with an approximate equalized flow pattern exiting the equalizer.

### RELATED APPLICATIONS

This application is related to mass flow devices, and more particularly, to a mass flow devices using a flow equalizer for improved output response.

### BACKGROUND

Various semiconductor processes require careful control of the amount, i.e., the mass, of material (usually in the form of a gas or vaporized liquid) provided to a work piece during fabrication. As a consequence, devices known as flow sensors have been devised to sense the mass flow rate of a gas or vapor. Flow sensors can be configured to meter the flow rate of a material, or when combined with control devices control the amount of the material being delivered to a work piece.

The two common types of sensors are pressure-based sensors and thermal-based sensors. Thermal-based sensors are devices which operate on heat transfer principles. A common commercial form incorporates a small diameter tube of capillary-sized dimensions, the tube having one or more coils of wire wound on the outside of the capillary tube in close proximity to each other. While one and three coil arrangements have been designed, the most commonly used design uses two coils wound on the outside of the capillary tube. The coils are formed from a material having a resistance which is temperature-sensitive, i.e., has a resistance as a function of temperature. Opposite ends of the capillary tube are in fluid communication with a larger passageway which transports the gas or vapor between a source of the gas or vapor and the processing station where the gas or vapor is utilized. A laminar flow element is disposed within the portion of the larger passageway called the bypass, between the upstream and downstream connections of the capillary tube to the larger passageway. The laminar flow element insures that the flow of gas or vapor through the bypass is laminar. As a gas or vapor flows through the sensor predetermined portions of the gas flow through both the bypass and capillary tube in a predetermined ratio known as a bypass ratio so long as the flow in the bypass remains laminar. By sensing the flow rate through the capillary tube, and knowing the bypass ratio, the flow rate through the entire mass flow device is proportional to the measured flow rate through the capillary tube.

The coils are typically connected in a bridge-type analog electrical circuit, or to the input of a digital system. The coils can then be heated by an electrical current to provide equal resistances in the absence of flow of the gas, and in the case of an analog electrical bridge-type circuit a balanced condition—e.g., a null output signal.

With the gas flowing within the sensor tube, within the relevant measuring range of the sensor, the temperature of the upstream coil is decreased by the cooling effect of the gas and the temperature of the downstream coil is increased by the heat first transferred from the upstream coil, and subsequently transferred by the gas or vapor to the downstream coil. This difference in temperature in fact is proportional to the number of molecules of gas per unit time flowing through the sensor. Therefore, based on the known variation of resistances of the coils with temperature, the output signal of the bridge circuit or digital circuit provides a measure of the gas mass flow.

An accurate output response requires the flow of gas or vapor in the bypass tube to be as close to laminar as possible. Turbulent flow increases flow noise, prevents the flow from dividing between the flow sensor and bypass in the desired ratio and can cause the pressure drop across the laminar flow element to be very sensitive to upstream conditions. Further, the flow sensor output can become non-linear with regard to the actual flow.

Metal screens, such as shown in U.S. Pat. No. 5,750,892 (Huang et al.) have been used upstream from the laminar flow element to equalize the flow across the diameter of the bypass tube, but metal screens cannot bring the flow noise down sufficiently for high flow mass flow devices. Further, the flow noise and the linearity are sensitive to the orientation of metal screens. Attempts have been made to employ laminar flow elements made of porous media, such as described U.S. Pat. No. 5,332,005 (Baan), where laminar flow elements are made from steel mesh confined at both ends by screen discs. However, when employing such laminar flow elements, the entrance conditions are different for the sensor flow path and the bypass flow path. Further, consistency and uniformity of the porous media is questionable. Finally, it is very difficult to model and design a porous media bypass for a mass flow controller due to the complexity of the porous structure.

### SUMMARY

In accordance with one aspect, a mass flow device comprises an inlet and an outlet; a bypass and a laminar flow element disposed within the bypass. The device also includes a sensor constructed so as to provide an output signal representative of the flow rate through the mass flow device, the sensor including a tube in fluid communication at an upstream location between the inlet and the laminar flow element, and a downstream connection between the laminar flow element and the outlet. A flow equalizer is disposed between the inlet and the upstream connection location, wherein the flow equalizer includes a porous medium constructed with an interconnected porosity so that gas or vapor exits the flow equalizer with a substantially equalized flow velocity profile so as to greatly reduce the flow disturbance to the sensor and improve the linearity of the flow sensor.

In accordance with another aspect a method is provide which improves the linearity of the sensor response of a mass flow device including an inlet and an outlet; a bypass and a laminar flow element disposed within the bypass and a sensor constructed so as to provide an output signal representative of the flow rate through the mass flow device, the sensor including a tube in fluid communication at an upstream location between the inlet and the laminar flow element, and a downstream connection between the laminar flow element and the outlet. The method comprises: disposing a flow equalizer between the inlet and the upstream connection location, wherein the flow equalizer includes a porous medium constructed with an interconnected porosity so that gas or vapor exits the flow equalizer with a substantially equalized flow velocity profile so as to greatly reduce the flow disturbance to the flow sensor so that the bypass split ratio for a wide range of flow rates will remain substantially constant.

### GENERAL DESCRIPTION OF THE DRAWINGS

FIG. 1 is a partial schematic, in cross-section, and partial block diagram showing flow velocity profile input of a high flow mass flow controller; and

FIG. 2 is a partial schematic, in cross-section, and partial block diagram of the preferred embodiment of a mass flow controller designed in accordance with the principles of the present disclosure.

### SPECIFIC DESCRIPTION OF THE DRAWINGS

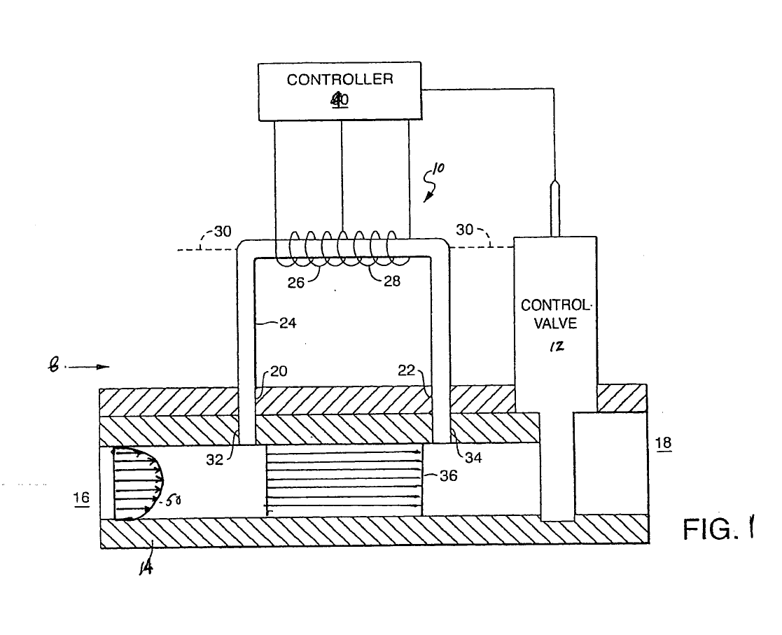

Referring to FIG. 1, a common type of mass flow controller 8 includes a mass flow sensor 10 and a control valve 12. The flow sensor 10 includes a main passageway 14 having an inlet 16 typically coupled to receive a gas or vapor from a source (not shown), an outlet 18 typically coupled to a tool or process system (not shown), such as a vacuum chamber, plasma generator, etc., and a section in between call a bypass. The upstream and downstream ends 20 and 22 of a small diameter tube 24 of capillary-sized dimensions are in fluid communication with the larger passageway 14 which transports the gas or vapor. The capillary tube typically is provided with two coils of wire 26 and 28 wound on the outside of the capillary tube in close proximity to each other. The coils 26 and 28 are positioned on the capillary tube 24 so that their coil axes are coaxial with respect to one another about the axis 30. The coils 26 and 28 are formed from a material having a resistance which is temperature-sensitive, i.e., has a resistance as a function of temperature. Opposite ends of the capillary tube 24 are in fluid communication with the larger main passageway 14 at upstream and downstream connections 32 and 34, respectively. The section of the main passageway between the connections 32 and 34 defines the bypass.

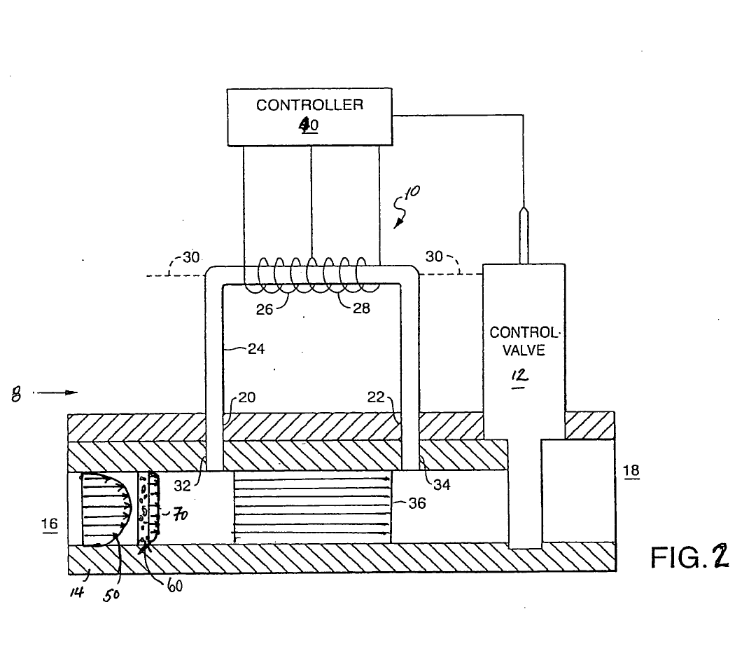

A laminar flow element 36 is disposed within the portion of the bypass 14, between the upstream and downstream connections 32 and 34. The laminar flow element can be a single device providing a narrow passageway between the laminar flow element and the way of the passageway of the bypass in which the laminar flow element is positioned. Other types of elements are known, including the use of small capillary-sized tubes (as shown in FIGS. 1 and 2) or corrugated elements, bundled together to provide the laminar flow element. See, for example, U.S. Pat. No. 6,318,171 issued Nov. 20, 2001 to Suzuki; and U.S. Pat. No. 7,107,834 issued Sep. 19, 2006 to Meneghini et al., both of which are assigned to the present assignee, and incorporated herein by reference. As a gas or vapor flows through the sensor 10 the laminar flow element is designed to establish laminar flow so that portions of the gas or vapor flow through both the bypass and capillary tubes in a predetermined ratio known as a bypass ratio. By sensing the flow rate through the capillary tube, and knowing the bypass ratio, the flow rate through the entire sensor is proportional to the measured flow rate through the capillary tube.

In a standard arrangement, a controller 40 is provided for sensing the signals provided by the sensor coils 26 and 28, and uses the signal to control the control valve 12 so as to form a mass flow controller for controlling the rate of flow through the device. Typically, the coils 26 and 28 are connected in a bridge-type electrical circuit, or other equivalent for measuring the two resistances, which as shown is formed as a part of the controller 40. The coils can then be heated by an electrical current from a current provided by the controller 40 to provide equal resistances in the absence of flow of the gas, and in the case of a bridge-type electrical circuit, a balanced condition for the bridge-type circuit, e.g., a null output signal. As gas flows through the capillary tube through the sensor, the upstream coil 28 will be at a lower average temperature than the downstream coil 26. This difference in temperature is proportional to the number of molecules per unit time flowing through the tube. Since the resistance of each coil is a function of the temperature of the coil, the difference in temperature can be measured by measuring the difference in resistances of the coils. Therefore, based on the known variation of resistance of the coils with temperature, the output signal of the bridge circuit or digital circuit provides a measure of the gas mass flow.

This difference in temperature of the two coils is proportional to the number of molecules per unit time flowing through the capillary tube. Therefore, based on the known variation of resistance of the coils with temperature, the output signal of the bridge circuit or digital circuit provides a measure of the gas mass flow.

As shown in FIG. 1, at 50, for a fully developed flow at the inlet at relatively high rates, the flow pattern becomes parabolic. That is, the flow velocity profile has a maximum velocity in the center of the passageway at the inlet, while a minimum (typically zero) velocity at the inner surface of the tube. For non-fully developed flow, it also has a similar flow pattern, although the maximum velocity in the center of the tube is not as great. The flow profile can be even more complicated where the inlet is not straight line as shown, but comes into the tube at an angle. When the inlet flow hits the laminar flow element, at high flow rates the high velocity flow portion creates a turbulence flow or a flow disturbance. This flow disturbance is the main cause of flow noise in the flow sensor signal. The magnitude of the flow disturbance is highly related to the velocity of the flow and the flow pattern.

Accordingly, according to the teachings of the present disclosure, provision is made to reduce the flow velocity, as well as reshape the flow pattern so that is more flat or equalized across the cross-dimension of the tube. If the flow velocity is reduced and the flow pattern is flat or flow is equalized, the flow disturbance will be minimized such that the flow noise on the flow sensor will be greatly reduced. Also, where the laminar flow element comprises a plurality of capillary sized tubes or corrugated elements, a flat/equalized flow profile pattern will improve the linearity between the sensor output and the actual flow because of the entrance effect for each flow bypass tube/corrugated flow tunnel and the flow sensor tube are the same. This is very important for multi-gases applications as the flow range is different for different gases, i.e., the maximum flow velocity is different.

As previously mentioned, screens alone are insufficient to achieving this design goal for high flow applications. High flow rates are generally considered to be those between about 2 SLM and about 200 SLM and greater, and more specifically between about 50 SLM and about 200 SLM and greater. Metal screens, such as shown in U.S. Pat. No. 5,750,892 (Huang et al.) cannot bring the flow noise down sufficiently for high flow mass flow controllers. Further, the flow noise and the linearity are sensitive to the orientation of multiple metal screens.

In accordance with the present disclosure, a porous medium of predetermined shape, dimensions, and porosity is used to provide a flow equalizer upstream from the laminar flow element as shown, for example, in FIG. 2. The flow equalizer is preferably in the form of a component, plug or disk of porous material indicated generally at 60, positioned in the inlet, upstream from the laminar flow element. The component 60 is preferably of uniform thickness, although the shape of the component can vary for certain applications. The thickness of the disk should not be too thick so as to make the differential pressure across the component too great since differential pressure is proportional to maximum flow, nor too thin so as to significantly sacrifice the uniform flow velocity profile. Such porous media are constructed with an interconnected porosity, i.e., pores are connected together and to the surfaces of the component so as to allow fluid flow from one side to the other so that flow through the media is virtually along random pathways, and thus more likely to exit from the component uniformly across the exit surface of the downstream side of the component so to achieve the approximate uniform velocity profile as indicated at 70 in FIG. 2. This is in contrast to structured passageways (such as offered by screens), that do not have provide random pathways. The pores define the open volume within the medium. The percent porosity is a rough measure of the open volume equal to 100% minus the pore density. The total open volume of the interconnected porosity is normally included in this value. Pore shape, pore size and pore size distribution are critical factors when describing the open volume available. A measure of porosity includes a particle retention rating which indicates the size of the particles removed from a fluid during filtration through the medium, i.e., it is a measure of the size of particles that can pass through the medium. Typical examples of particle retention ratings for components 60 used in mass flow devices are 100 microns and 50 microns, although this can vary. One example, is a disk having a particle retention rating of 100 microns having a thickness of about 0.062 inches. Micron grade or micron rating is a comparative test result to describe the size of a hard spherical particle that is retained by the interconnected porosity. The micron rating is normally calculated from the pressure required to cause air to bubble from the largest port in the component when submerged in a test liquid. The value is frequently referred to as the “bubble point” and is highly dependent on pore shape. Finally, permeability is defined as the rate of fluid flow per specified surface area of a porous material at a given pressure differential. The porous material component 60 is preferably made of a material that will be non-reactive with the gas and vapors with which the mass flow controller is to be used. The preferred material is stainless steel, although for some applications other materials can be used, such as bronze, nickel and nickel-based alloys and titanium. The component can be made in accordance with any one of several known sintering techniques, such as axial compaction and sintering, gravity sintering, powder rolling and sintering, isostatic compaction and sintering, metal spraying, metal coating and sintering and metal injection molding and sintering.

Use of component 60 for high flow rates in the range of about 2 SLM and about 200 SLM provides an significant, almost 10 fold improvement in signal to noise ratio of the output from the sensor, when compare to the use of screens.

Use of component 60 thus greatly reduces the flow disturbance to the flow sensor with a more uniform flow velocity profile. This is true regardless of the direction of the inlet flow. Further, it improves the linearity between the flow sensor output and the actual flow rate. Finally, the component 60 at the inlet doesn't require the tight specification on the consistency of porous media as it not a part of the laminar flow or bypass element. The use of the component 60 thus provides an easy way to make a high flow mass flow meter/controller with low flow noise and good linearity, i.e., maintains a constant bypass ratio for a wide range of flow rates. The component 60 is especially effective when used with small capillary-sized tubes (as shown in FIGS. 1 and 2) or corrugated elements, bundled together to provide the laminar flow element.

While the porous medium is described as including sintered material, it should be evident that other arrangements can be made. For example, the porous medium having an interconnected porosity can be created using a plurality of screens having interstitial openings which are non-aligned between adjacent screens so as to create an interconnected porosity structure.

The mass flow system and method of the present disclosure as disclosed herein, and all elements thereof, are contained within the scope of at least one of the following claims. No elements of the presently disclosed system and method are meant to be disclaimed, nor are they intended to necessarily restrict the interpretation of the claims. In these claims, reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference, and are intended to be encompassed by the claims. Moreover, nothing disclosed herein is intended to be dedicated to the public, regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A mass flow device comprising:
an inlet and an outlet;
a bypass and a laminar flow element disposed within the bypass;
a sensor constructed so as to provide an output signal representative of the flow rate through the mass flow device, the sensor including a tube in fluid communication at an upstream location between the inlet and the laminar flow element, and a downstream connection between the laminar flow element and the outlet; and
a flow equalizer is disposed between the inlet and the upstream connection location, wherein the flow equalizer includes a porous medium constructed with an interconnected porosity so that gas or vapor exits the flow equalizer with a substantially equalized flow velocity profile so as to greatly reduce the flow disturbance to the flow sensor and improve the linearity of the flow sensor response.

2. The mass flow device according to claim 1, wherein the porous medium includes sintered material.

3. The mass flow device according to claim 2, wherein the porous medium includes a sintered material selected from the group consisting of stainless steel, bronze, nickel, nickel-based alloys and titanium

4. The mass flow device according to claim 1, further including a control valve, wherein the control valve is controlled as a function of the sensor output signal so that the device operates as a mass flow controller.

5. The mass flow device according to claim 1, wherein the laminar flow element includes a plurality of bypass tubes.

6. The mass flow device according to claim 1, wherein the laminar flow element includes corrugated elements.

7. The mass flow device according to claim 1, wherein the flow equalizer includes a porous medium is constructed with a thickness that provides a substantially equal flow velocity profile for flows within the range of 2 SLM and 200 SLM or greater.

8. The mass flow device according to claim 1, wherein the flow equalizer includes disk porous medium constructed with an interconnected porosity so that gas or vapor exits the flow equalizer with a substantially equalized flow velocity profile so as to greatly reduce the flow disturbance to the flow sensor and improve the linearity of the flow sensor response.

9. The mass flow device according to claim 1, wherein the flow equalizer includes a plurality of porous screens arranged so as to provide a substantially equalized flow velocity so as to greatly reduce the flow disturbance to the flow sensor and improve the linearity of the flow sensor response.

10. The mass flow device according to claim 1 wherein the porous medium includes a plurality of layers of screens arranged so as to provide the interconnected porosity.

11. The mass flow device according to claim 1, wherein the porous medium is constructed so as to maintain a constant bypass split ratio for a wide range of flow rates.

12. A method of improving the linearity of the sensor response of a mass flow device including an inlet and an outlet; a bypass and a laminar flow element disposed within the bypass and a sensor constructed so as to provide an output signal representative of the flow rate through the mass flow device, the sensor including a tube in fluid communication at an upstream location between the inlet and the laminar flow element, and a downstream connection between the laminar flow element and the outlet, the method comprising:
disposing a flow equalizer between the inlet and the upstream connection location, wherein the flow equalizer includes a porous medium constructed with an interconnected porosity so that gas or vapor exits the flow equalizer with a substantially equalized flow velocity profile so as to greatly reduce the flow disturbance to the flow sensor so that the bypass split ratio for a wide range of flow rates will remain substantially constant.
